(19) United States
(12) Patent Application Publication
(10) Pub. No.: US 2007/0036936 A1
(43) Pub. Date: Feb. 15, 2007

(54) Mat for use in an automobile and a method for manufacturing the same

(75) Inventors: Kazuhumi Shimizu, Nara (JP); Shinsuke Sugie, Nara (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: SUMINOE TEXTILE CO., LTD., Osakashi (JP)

(21) Appl. No.: 11/484,851

(22) Filed: Jul. 12, 2006

(30) Foreign Application Priority Data
Jul. 14, 2005 (JP) 2005-205071

(51) Int. Cl. B32B 33/00; B32B 3/02; D05C 17/02

(52) U.S. Cl. 428/95; 428/96

(57) ABSTRACT

A method of manufacturing a mat for use in an automobile according to the present invention includes a first application step for applying first water type resin emulsion 31 containing water repellent agent onto one surface of a nonwoven fabric 30, a second application step for applying second water type resin emulsion 32 containing resin having a glass transition temperature of 55° C. or below onto the first water type resin emulsion applied surface of the nonwoven fabric 30, and a lamination step for integrally laminating a surface skin material on the other surface of the nonwoven fabric 30 after the second application step. With this manufacturing method, a mat for use in an automobile excellent in sound absorbing performance and slip prevention performance with respect to the underneath or bottom surface can be manufactured.

This application claims priority to Japanese Patent Application No. 2005-205071 filed on Jul. 14, 2005, the disclosure of which is incorporated by reference in its entirety.

### BACKGROUND OF THE INVENTION

1. Technical Field

The present invention relates to a mat for use in an automobile and a method for manufacturing the same. In this specification, the term “resin” is used to mean both resin and rubber.

2. Prior Art

Conventionally, a floor mat is disposed on a floor in an automobile for the purpose of, e.g., feet comfort and preventing transmission of vibrations from underneath. When an external force due to, e.g., stepping or kicking with the feet is applied to the floor mat, the floor mat may be displaced by sliding. As a floor mat for preventing such displacement, a floor mat in which embossed (concavo-convex) configuration is given to a rubber forming a rear surface of the mat is known (see Japanese Unexamined Laid-open Patent Publication No. H10-99183).

In the meantime, in recent years, in order to enhance the comfort in an automobile, it has been strongly desired to further improve the quietness in an automobile. In the aforementioned conventional floor mat, however, the sound absorbing effect was insufficient to satisfy such desire because of the poor air permeability of the embossed rubber layer. Under the circumstances, in recent years, a floor mat in which a nonwoven fabric is laminated on the rear surface side of the surface skin material such as a carpeting material has come into use (see Japanese Unexamined Laid-open Patent Publication no. 2002-200687). According to this structure, sufficient sound absorbing performance could be attained since sound, such as, e.g., noise, is absorbed mainly when it passes through the nonwoven fabric layer.

In the conventional structure in which a nonwoven fabric is laminated on the rear side of the surface skin material, however, there is a problem that almost no slip prevention performance with respect to the rear surface can be obtained. Therefore, in order to improve the slip prevention performance, the present inventors manufactured a mat in which a rear side nonwoven fabric layer was entirely impregnated with latex emulsion, and then evaluated the slip prevention performance. The evaluation revealed that sufficient slip prevention performance could not be obtained though it was confirmed that the slip prevention performance was improved to some degree.

The present invention was made in view of the aforementioned technical background, and aims to provide a mat for use in an automobile excellent in sound absorbing performance and excellent in slip prevention performance with respect to the rear surface and its manufacturing method.

Other objects of the present invention will be apparent from the below mentioned embodiments.

### SUMMARY OF THE INVENTION

In order to attain the aforementioned objects, the present invention provides the following:

[1] A method of manufacturing a mat for use in an automobile, having:

a first application step for applying first water type resin emulsion containing water repellent agent onto one surface of a nonwoven fabric;

a second application step for applying second water type resin emulsion containing resin having a glass transition temperature of 55° C. or below onto the first water type resin emulsion applied surface of the nonwoven fabric; and

a lamination step for integrally laminating a surface skin material on the other surface of the nonwoven fabric after the second application step.

[2] A method of manufacturing a mat for use in an automobile, having:

a first application step for applying first water type resin emulsion containing water repellent agent onto one surface of a nonwoven fabric;

a second application step for applying second water type resin emulsion containing resin having a glass transition temperature of 55° C. or below onto the other surface of the nonwoven fabric; and

a lamination step for integrally laminating a surface skin material on the one surface of the nonwoven fabric after the second application step.

[3] A method of manufacturing a mat for use in an automobile, having:

a lamination step for laminating a nonwoven fabric and a surface skin material to obtain a laminated sheet;

a first application step of applying first water type resin emulsion containing water repellent agent onto a rear surface of the nonwoven fabric of the laminated sheet; and

a second application step for applying second water type resin emulsion containing resin having a glass transition temperature of 55° C. or below onto a rear surface of the nonwoven fabric of the laminated sheet after the first application step.

[4] The method of manufacturing a mat for use in an automobile as recited in any one of the aforementioned Items 1 to 3, wherein as the first water type resin emulsion to be used at the first application step, water type resin emulsion having a solid content of 30 to 60 mass % containing water repellent agent of 0.5 to 60 mass parts with respect to resin 100 mass parts is used, and wherein as the second water type resin emulsion to be used at the second application step, water type resin emulsion having a solid content of 30 to 60 mass % is used.

[5] The method of manufacturing a mat for use in an automobile as recited in any one of the aforementioned Items 1 to 4, wherein a number of aggregated dot-like portions made of resin are formed on the second water type resin emulsion applied surface of the nonwoven fabric by applying the second water type resin emulsion.

[6] A mat for use in an automobile, wherein a nonwoven fabric layer is integrally laminated at a lower surface side of a surface skin material layer, wherein a water repellent resin impregnated layer impregnated with resin containing water repellent agent is formed within the nonwovern fabric at at least a part of the thickness direction of the nonwoven fabric layer, and wherein a slip preventing portion impregnated with resin having a glass transition temperature of 55° C. or below is formed on at least a rear surface of the nonwoven fabric layer.

[7] The mat for use in an automobile as recited directly above, wherein the water repellent resin impregnated layer impregnated with resin containing water repellent agent is formed on the entirety of the nonwoven fabric layer.

[8] The mat for use in an automobile as recited above in Item 6 or 7, wherein the slip preventing portion is constituted by a number of dispersed aggregated dot-like portions each having a diameter of 0.5 to 5 mm formed by impregnated and adhered resin on the rear surface of the nonwoven fabric layer.

[9] The mat for use in an automobile as recited above in Items 6 to 8, wherein the weight per unit area of the fibers constituting the nonwoven fabric layer is 100 to 750 g/m², wherein the adhered amount of the water repellent resin impregnated layer is 30 to 300 g/m², and wherein the slip preventing portion is 50 to 300 g/m².

[10] The mat for use in an automobile as recited above in Items 6 to 9, wherein as the surface skin material layer, a carpet original fabric in which piles are embedded on an upper surface of a base fabric and a lower surface of the base fabric is precoat-processed is used, and wherein the surface skin material layer and the nonwoven fabric layer are integrally bonded via a permeable adhesive resin layer having weight per unit area of 30 to 500 g/m² formed by heating and fusing thermoplastic resin powder.

According to the invention as recited in the aforementioned Items [1], [2] and [3], by applying the water type resin emulsion containing water repellent agent onto the nonwoven fabric, a water repellent resin impregnated layer impregnated with resin containing water repellent agent is formed within the nonwoven fabric layer on at least a part of a thickness direction of the nonwoven fabric layer, and then slip preventing water type resin emulsion containing resin having a glass transition temperature of 55° C. or below is applied. Therefore, the slip preventing resin will be aggregated on the surface of the nonwoven fabric layer due to the repellant function of the water repellent resin impregnated layer, resulting in excellent slip prevention performance due to the slip preventing portion made of aggregated resin (glass transition temperature of 55° C. or below) on the surface of the nonwoven fabric layer. Furthermore, since the water repellent resin impregnated layer and the slip preventing portion are formed by applying the water type resin emulsion onto the nonwoven fabric layer, sufficient air permeability as a mat can be secured, resulting in excellent sound absorbing performance.

According to the invention as recited in the aforementioned Item [4], as the first water type resin emulsion to be used at the first application step, water type resin emulsion having a solid content of 30 to 60 mass% containing water repellent agent of 0.5 to 60 mass parts with respect to resin 100 mass parts is used. Therefore, the water repellent function of the water repellent resin impregnated layer can be further enhanced, which makes it possible to easily form the slip preventing portion in which a number of aggregated dot-like portions each having a diameter of 0.5 to 5 mm are dispersed, resulting in excellent slip prevention performance with respect to the laying (or rear) substrate surface.

According to the invention as recited in Item [5], a mat for use in an automobile further enhanced in slip prevention performance with respect to the laying substrate surface can be manufactured.

According to the invention as recited in Item [6], since the slip preventing portion impregnated with resin having a glass transition temperature of 55° C. or below is formed on at least the rear surface of the nonwoven fabric layer, excellent slip prevention performance with respect to the laying substrate surface can be secured.

According to the invention as recited in Item [7], since the water repellent resin impregnated layer impregnated with resin containing water repellent agent is formed in the entirety of the nonwoven fabric layer, water repellent performance sufficient for a mat for use in an automobile can be achieved.

According to the invention as recited in Item [8], since the slip preventing portion is constituted by a number of dispersed aggregated dot-like portions each having a diameter of 0.5 to 5 mm formed by impregnated and adhered resin on the rear surface of the nonwoven fabric layer, excellent slip prevention performance with respect to the laying substrate surface can be secured.

According to the invention as recited in Item [9], slip prevention performance with respect to the laying substrate surface can be further enhanced while maintaining the lightweight properties.

According to the invention as recited in Item [10], sufficient slip prevention performance with respect to the laying substrate surface can be achieved while maintaining the excellent sound absorbing performance.

### BRIEF DESCRIPTION OF THE DRAWINGS

The aforementioned objects, other objects, features and advantages of the present invention will become more apparent by referring the preferred embodiments of the invention which will be detailed with reference to the attached drawings.

FIG. 1 is a cross-sectional view showing an embodiment of a floor mat for use in an automobile according to the present invention;

FIG. 2 is a partially enlarged schematic plan view showing a part of the rear surface of the mat for use in an automobile shown in FIG. 1;

FIG. 3 is a cross-sectional view showing another embodiment of a mat for use in an automobile;

FIG. 4 is a cross-sectional view showing still another embodiment of a floor mat for use in an automobile;

FIG. 5 is a view showing an example of a manufacturing method according to the present invention;

FIG. 6 is a view showing another example of a manufacturing method according to the present invention;

FIG. 7 is a view showing still another example of a manufacturing method according to the present invention; and

FIG. 8 is an explanatory view of a slip resistance evaluation method.

### DETAILED DESCRIPTION OF THE PREFERRED EMBODIMENTS

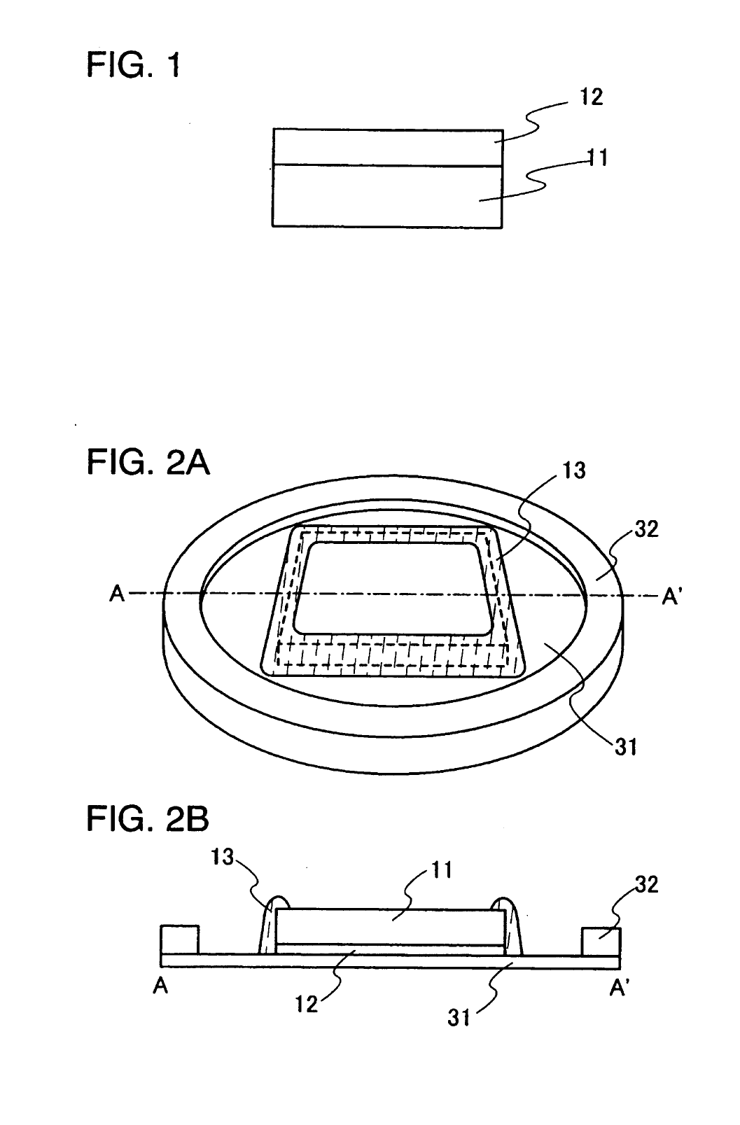

An embodiment of a mat 1 for use in an automobile according to the present invention is shown in FIG. 1. In FIG. 1, “10” denotes a surface skin material layer, “6” denotes a nonwoven fabric layer, and “7” denotes a slip preventing portion.

The surface skin material layer 10 consists of a base fabric 2, piles 3 embedded on the upper surface of the base fabric 2 and a precoat layer 4 formed on the lower surface of the base fabric 2 by precoat-processing, and has air permeability. The surface skin material layer 10 and the nonwoven fabric layer 6 are integrally bonded to each other via a permeable adhesive resin layer 5. In the entire nonwoven fabric layer 6, a water repellent resin impregnated layer 8 impregnated with resin containing water repellent agent is formed. Furthermore, at the lower surface of the nonwoven fabric layer 6, the slip preventing portion 7 impregnated with resin having a glass transition temperature of 55° C. or below is formed.

As shown in FIG. 2, the slip preventing portion 7 is constituted by a number of dispersed aggregated dot-like portions 11 formed by impregnated and adhered resin. In FIG. 2, “12” denotes a fiber constituting the nonwoven fabric. The aggregated dot-like portion 11 is disposed with at least a part of the aggregated dot-like portion 1 downwardly protruded from the lower surface of the nonwoven fabric layer 6 (see the enlarged view in FIG. 1). It is preferable that the aggregated dot-like portion 11 is 0.5 to 5 mm in diameter. By setting the diameter so as to fall within such a range, sufficient slip prevention performance with respect to the laying substrate surface can be exerted.

In mat 1 for use in an automobile constituted as mentioned above, since the slip preventing portion 7 fixedly impregnated with resin having a glass transition temperature of 55° C. or below is formed at the rear surface of the nonwoven fabric layer 6, excellent slip prevention performance with respect to the laying substrate surface can be achieved. Furthermore, since the slip preventing portion 7 is constituted by a number of dispersed aggregated dot-like portions 11 formed by impregnated and adhered resin, the slip prevention performance with respect to the laying substrate surface can be further improved.

In the embodiment (see FIG. 1), although the water repellent resin impregnated layer 8 impregnated with resin containing water repellent agent is formed in the entire nonwoven fabric layer 6, the present invention is not especially limited to such a structure. For example, as shown in FIGS. 3 and 4, it is possible to construct such structure that the water repellent resin impregnated layer 8 impregnated with resin containing water repellent agent is formed within the nonwoven fabric layer 6 at a part of the thickness direction of the nonwoven fabric layer 6.

That is, in mat 1 shown in FIG. 3, the water repellent resin impregnated layer 8 fixedly impregnated with resin containing water repellent agent is formed at a part of the rear side within the nonwoven fabric layer 6 and provided with a slip preventing portion 7 fixedly impregnated with resin having a glass transition temperature of 55° C. or below at the rear side within the nonwoven fabric layer 6.

Furthermore, in mat 1 shown in FIG. 4, a water repellent resin impregnated layer 8 fixedly impregnated with resin containing water repellent agent is formed at the thickness intermediate portion of the nonwoven fabric 6 and the upper side of the nonwoven fabric layer 6 and provided with a slip preventing portion 7 fixedly impregnated with resin having a glass transition temperature of 55° C. or below at the rear side within the nonwoven fabric layer 6 and the lower side of the nonwoven fabric layer 6. In other words, the impregnated resin constituting the water repellent resin impregnated layer 8 and the impregnated resin constituting the slip preventing portion 7 are joined to each other within the nonwoven fabric layer 6.

Next, the manufacturing method of the automobile mat 1 having the aforementioned structure will be explained.

(First Manufacturing Method)

Initially, as shown in FIG. 5, first water type resin emulsion 31 containing water repellent agent is applied onto one surface of the nonwoven fabric 30 (first application step), which is then heated and dried with a first heating apparatus 21A. Subsequently, second water type resin emulsion 32 containing resin having a glass transition temperature of 55° C. or below is sprayed onto the first water type resin emulsion applied surface of the nonwoven fabric 30 via a spray nozzle portion 23 (second application step). Thereafter, it is heated and dried with a second heating apparatus 22A. Then, a surface skin material 10 is integrally laminated on the first water type resin emulsion non-applied surface of the nonwoven fabric 30.

In cases where the first water type resin emulsion 31 is sufficiently impregnated into the nonwoven fabric 30 at the first application step, for example, mat 1 for use in an automobile as shown in FIG. 1 can be obtained. On the other hand, in cases where the first water type resin emulsion 31 is lightly impregnated into the nonwoven fabric 30 at the first application step, for example, mat 1 for use in an automobile as shown in FIG. 3 can be obtained. The adjustment of such a resin impregnation degree can be performed by changing the application amount of the resin and/or the angle of the doctor blade 20.

(Second Manufacturing Method)

Initially, as shown in FIG. 6, first water type resin emulsion 31 containing water repellent agent is applied onto one surface of the nonwoven fabric 30 (first application step), which is then heated and dried with a first heating apparatus 21B. Subsequently, second water type resin emulsion 32 containing resin having a glass transition temperature of 55° C. or below is sprayed onto the first water type resin emulsion non-applied surface of the nonwoven fabric 30 via a spray nozzle portion 24 (second application step). Thereafter, it is heated and dried with a second heating apparatus 22B. Then, a surface skin material 10 is integrally laminated on the first water type resin emulsion applied surface of the nonwoven fabric 30.

In cases where the first water type resin emulsion 31 is sufficiently impregnated into the nonwoven fabric 30 at the first application step, for example, mat 1 for use in an automobile as shown in FIG. 1 can be obtained. On the other hand, in cases where the first water type resin emulsion 31 is lightly impregnated into the nonwoven fabric 30 at the first application step, for example, mat 1 for use in an automobile as shown in FIG. 4 can be obtained. The adjustment of such a resin impregnation degree can be performed by changing the application amount of the resin and/or the angle of the doctor blade 20.

(Third Manufacturing Method)

Initially, a nonwoven fabric 30 and a surface skin material 33 are laminated to thereby obtain a laminated sheet 34. Then, as shown in FIG. 7, first water type resin emulsion 31 containing water repellent agent is applied onto a rear surface of the nonwoven fabric 30 of the laminated sheet 34 (first application step), which is then heated and dried with a first heating apparatus 21C. Subsequently, second water type resin emulsion 32 containing resin having a glass transition temperature of 55° C. or below is sprayed onto the first water type resin emulsion applied surface of the nonwoven fabric 30 via a spray nozzle portion 25 (second application step). Thereafter, it is heated and dried with a second heating apparatus 22C.

In cases where the first water type resin emulsion 31 is sufficiently impregnated into the nonwoven fabric 30 at the first application step, for example, mat 1 for use in an automobile as shown in FIG. 1 can be obtained. On the other hand, in cases where the first water type resin emulsion 31 is lightly impregnated into the nonwoven fabric 30 at the first application step, for example, mat 1 for use in an automobile as shown in FIG. 3 can be obtained. The adjustment of such a resin impregnation degree can be performed by changing the application amount of the resin and/or the angle of the doctor blade 20.

In any one of the first manufacturing method, the second manufacturing method and the third manufacturing method, the slip preventing resin (the second water type resin emulsion) will be aggregated on the surface of the nonwoven fabric in a dot-like manner due to the water repellant function of the water repellent resin impregnated layer 8 (the first water type resin emulsion). Thus, the aggregated dot-like portion (dot-like portion of resin having a glass transition temperature of 55° C. or below) formed on the surface of the nonwoven fabric layer 6 can attain excellent slip prevention performance. Furthermore, since the water repellent resin impregnated layer 8 and the slip preventing portion 7 are formed by applying the water type resin emulsion onto the nonwoven fabric, sufficient air permeability as mat 1 can be secured, resulting in excellent sound absorbing performance.

In the aforementioned first to third manufacturing methods, although it is possible to eliminate the heat and dry processing by the heating apparatus 21(22), it is preferable to execute the processing in each method. Furthermore, the application method of the first water type resin emulsion 31 and that of the second water type resin emulsion 32 are not specifically limited, and can be, for example, a spraying method or a roll coating method.

The aforementioned first to third embodiments are exemplified as preferred embodiments, and therefore the present invention is not specifically limited to one of the manufacturing methods.

In the present invention, as the base fabric 2, although it is not specifically limited, for example, a spunbonded nonwoven fabric, a needle-punched nonwoven fabric and a woven fabric can be exemplified. Among these fabrics, it is preferable to use a spunbonded nonwovern fabric. In this case, more air gaps communicating the surface side of the fabric with the rear side thereof can be formed even after executing precoat-processing, resulting in more excellent air permeability, which in turn can further enhance the sound absorbing performance.

The weight per unit area of the base fabric 2 is preferably set to 80 to 150 g/m². Setting it to 80 g/m² or more enables the piles 3 to be stably supported by the base fabric 2, and setting it to 150 g/m² or less enables sufficient air permeability, resulting in sufficient sound absorbing performance.

Furthermore, the weight per unit area of the piles 3 is preferably set so as to be within the range of 250 to 2,000 g/m².

The precoat layer 4 is a resin layer formed by applying emulsion or solution of resin or rubber. The adhered amount (dry condition) of the resin in the precoat layer 4 is preferably set to 30 to 200 g/m². Setting the amount to 30 g/m² or above results in sufficient pile-pull-out strength, which can prevent the piles from being pulled out. Setting the amount to 200 g/m² or less results in sufficient air permeability, which in turn can obtain sufficient sound absorbing performance.

The thickness of the nonwoven layer 6 is preferably set to 1 to 20 mm. Setting it to 1 mm or above results in sufficient sound absorbing performance. Setting it to 20 mm or less results in sufficient comfort regarding the automobile compartment space. The thickness of the sound absorbing nonwoven fabric layer 6 is preferably set to 1.5 to 15 mm.

The weight per unit area of the fibers constituting the nonwoven fabric layer 6 is preferably set to 100 to 750 g/m². Setting it to 100 g/m² or above results in sufficient sound absorbing effects, and setting it to 750 g/m² or less results in sufficient air permeability, which in turn can obtain sufficient sound absorbing performance.

Although the type of nonwoven fabric constituting the nonwoven fabric layer 6 is not specifically limited, for example, a spunbonded nonwoven fabric, a needle-punched nonwoven fabric, etc., can be exemplified.

As the resin constituting the water repellent resin impregnated layer 8, i.e., the resin constituting the first water type repellent resin emulsion to be used at the first application step, although it is not specifically limited, for example, SBR (styrene-butadiene rubber), EVA (ethylene-vinyl acetate copolymer resin), vinyl chloride resin, acrylic resin, etc., can be exemplified. From the viewpoint of economy, it is preferable to use SBR.

As the water repellent agent constituting the water repellent resin impregnated layer 8, i.e., the water repellent agent constituting the first water type resin emulsion to be used at the first application step, although it is not specifically limited, for example, fluorine series water repellent agent, silicone resin water repellent agent, etc., can be exemplified. It is preferable to use fluorine series water repellent agent since higher repellency can be given.

As the first water type resin emulsion 31, it is preferable to use water type resin emulsion having a solid content of 30 to 60 mass % containing water repellent agent of 0.5 to 60 mass parts with respect to resin 100 mass parts. In the case of employing such structure, the water repellent function of the water repellent resin impregnated layer 8 can be more enhanced, which enables assured formation of the slip preventing portion 7 in which a number of aggregated dot-like portions each having a diameter of 0.5 to 5 mm are dispersed.

The adhered amount (dry condition) of the water repellent resin impregnated layer 8 preferably falls within the range of 30 to 300 g/m². Setting the adhered amount to 30 g/m² or more results in sufficient water repellent effects and a number of aggregated dot-like portions. Setting the adhered amount to 300 g/m² or less results in sufficient air permeability, which in turn can secure sufficient sound absorbing performance.

As the resin constituting the slip preventing portion 7, i.e., the resin constituting the second water type resin emulsion 32, resin having a glass transition temperature of 55° C. or below is used. Although the resin having a glass transition temperature of 55° C. or below is not specifically limited, for example, SBR (styrene-butadiene rubber), acrylic resin, etc., can be exemplified. Using the resin having a glass transition temperature of 55° C. or below results in sufficient slip preventing effects by the slip preventing portion 7.

As the second water type resin emulsion 32, it is preferable to use water type resin emulsion having a solid content of 30 to 60 mass %. Water repellent agent is not usually added to the second water type resin emulsion 32.

The adhered amount (dry condition) of the slip preventing portion 7 is preferably within the range of 50 to 300 g/m². Setting the adhered amount to 50 g/m² or more results in sufficient slip preventing effects. Setting the adhered amount to 300 g/m² or less results in sufficient air permeability, which in turn can secure sufficient sound absorbing performance.

It is preferable that the slip preventing portion 7 is constituted by a number of dispersed aggregated dot-like portions 11 each having a diameter of 0.5 to 5 mm formed by resin impregnated in and fixed on the rear surface of the nonwovn fabric 6 (see FIG. 2). In cases where such structure is employed, there is an advantage that the slip prevention performance with respect to the laying substrate surface can be further enhanced. Among other things, it is especially preferable that the diameter of the aggregated dot-like portion 11 is 0.8 to 3 mm.

The permeable adhesive resin layer 5 is preferably an adhesive layer formed by heating and melting thermoplastic resin powder. As the thermoplastic resin powder, although it is not specifically limited, it is preferable to use a polyolefin series resin. As the polyolefin series resin, for example, polyethylene, polypropylene, amorphous polyolefin (APAO), etc., can be exemplified. The application amount of the thermoplastic resin powder, i.e., the weight per unit area of the permeable adhesive resin layer 5, is preferably set to 30 to 500 g/m². Setting it to 30 g/m² or above results in sufficient adhesive force. Setting it to 500 g/m² or less results in sufficient air permeability, which in turn can secure sufficient sound absorbing performance.

It is preferable that the average particle diameter of the thermoplastic resin powder is 90 to 1,000 μm. Setting it to 90 μm or above makes the powder difficult to be lifted up, thereby improving the working environment. Setting it to 1,000 μm or less causes easy melting of the thermoplastic resin power, resulting in sufficient adhesive strength.

Next, concrete examples of the present invention will be explained. It should be understood, however, that the present invention is not specifically limited to these examples.

### EXAMPLE 1

As shown in FIG. 5, on one surface of a nonwoven fabric 30 of 300 g/m², first water type resin emulsion 31 having a solid content of 50 mass % containing water repellent agent of 11 mass parts with respect to SBR 100 mass parts was applied.

Thereafter, it was subjected to heat and dry processing with a first heating apparatus 21A.

As the water repellent agent, “NK Guard FSN-78” (fluorine series resin) manufactured by Nicca Chemical Co., Ltd. was used.

Next, second water type resin emulsion 32 having a solid content of 50 mass % containing acrylic resin (55° C. in glass transition temperature) was sprayed onto the first water type resin emulsion applied surface of the nonwoven fabric 30. Thereafter, it was subjected to heat and dry processing to thereby obtain a processed nonwoven fabric layer.

On the other hand, on the rear surface of the fabric in which nylon yarn piles 650 g/m² in weight per unit area were tufted to a base fabric 120 g/m² in weight per unit area made of PET (polyethylene terephthalate) fiber supnbonded nonwoven fabric, SBR latex was precoated to form a precoat layer 4 which was 100 g/m² in dry weight per unit area. Thus, a carpet original fabric was obtained.

While moving the carpet original fabric with the pile surface facing downward at a constant speed, polyethylene powder having an average particle diameter of 400 μm was sprayed onto the carpet original fabric at the spraying amount of 300 g/m². Thereafter, after heating the powder, the emulsion non-applied surface of the processed nonwoven fabric layer was interposed on the heated powder. Then, they were pressed with cold pressure rollers to thereby obtain mat 1 for use in an automobile as shown in FIG. 1.

In the obtained mat 1 for use in an automobile, the adhered amount of the water repellent resin impregnated layer 8 was 50 g/m², and the adhered amount of the slip preventing portion 7 was 120 g/m². The slip preventing portion 7 was constituted by a number of dispersed aggregated dot-like portions 11 each having an average diameter of 3 mm formed by impregnated and adhered resin.

### EXAMPLE 2

As shown in FIG. 6, on one surface of a nonwoven fabric 30 of 300 g/m², first water type resin emulsion 31 having a solid content of 45 mass % containing water repellent agent of 15 mass parts with respect to SBR 100 mass parts was applied. Thereafter, it was subjected to heat and dry processing with a first heating apparatus 21B. As the water repellent agent, “NK Guard FSN-78” (fluorine series resin) manufactured by Nicca Chemical Co., Ltd. was used.

Next, second water type resin emulsion 32 having a solid content of 45 mass % containing acrylic resin (55° C. in glass transition temperature) was sprayed onto the first water type resin emulsion non-applied surface of the nonwoven fabric 30. Thereafter, it was subjected to heat and dry processing to thereby obtain a processed nonwoven fabric layer.

On the other hand, on the rear surface of the fabric in which nylon yarn piles 650 g/m² in weight per unit area were tufted to a base fabric 120 g/m² in weight per unit area made of PET (polyethylene terephthalate) fiber spunbonded nonwoven fabric, SBR latex was precoated to form a precoat layer 4 which was 100 g/m² in dry weight per unit area. Thus, an original fabric was obtained for a carpet.

While moving the carpet original fabric with the pile surface facing downward at a constant speed, polyethylene powder having an average particle diameter of 400 μm was sprayed onto the carpet original fabric at the spraying amount of 300 g/m². Thereafter, after heating the powder, the first water type resin emulsion applied surface of the processed nonwoven fabric layer was interposed on the heated powder side of the carpet original fabric. Then, they were pressed with cold pressure rollers to thereby obtain mat 1 for use in an automobile as shown in FIG. 4.

In the obtained mat 1 for use in an automobile, the adhered amount of the water repellent impregnated resin layer 8 was 70 g/m², and the adhered amount of the slip preventing portion 7 was 100 g/m². The slip preventing portion 7 was constituted by a number of dispersed aggregated dot-like portions 11 having an average diameter of 4 mm formed by impregnated and adhered resin.

### EXAMPLE 3

On the rear surface of the fabric in which nylon yarn piles 450 g/m² in weight per unit area were tufted to a base fabric 2 which was 120 g/m² in weight per unit area made of PET (polyethylene terephthalate) fiber supnbonded nonwoven fabric, SBR latex was precoated to form a precoat layer 4 which was 100 g/m² in dry weight per unit area. Thus, a carpet original fabric was obtained.

While moving the carpet original fabric with the pile surface facing downward at a constant speed, polyethylene powder having an average particle diameter of 400 μm was sprayed onto the carpet original fabric at the spraying amount of 300 g/m². Thereafter, after heating the powder, a nonwoven fabric 30 which was 300 g/m² in weight per unit area was interposed on the heated powerder side of the carpet original fabric. Then, they were pressed with cold pressure rollers to thereby obtain a laminated sheet 34.

Next, as shown in FIG. 7, on the rear surface of the nonwoven fabric 30 of the laminated sheet 34, first water type resin emulsion 31 having a solid content of 55 mass % containing water repellent agent of 5 mass parts with respect to SBR 100 mass parts was applied. Thereafter, it was subjected to heat and dry processing with a first heating apparatus 21C. As the water repellent agent, “NK Guard FSN-78” (fluorine series resin) manufactured by Nicca Chemical Co., Ltd. was used.

Next, second water type resin emulsion 32 having a solid content of 55 mass % containing acrylic resin (55° C. in glass transition temperature) was sprayed onto the first water type resin emulsion applied surface of the nonwoven fabric 30 of the laminated sheet 34. Thereafter, it was subjected to heat and dry processing with a second heating apparatus 22 to thereby obtain mat 1 for use in an automobile as shown in FIG. 3.

In the obtained mat 1 for use in an automobile, the adhered amount of the water repellent impregnated resin layer 8 was 70 g/m², and the adhered amount of the slip preventing portion 7 was 80 g/m². The slip preventing portion 7 was constituted by a number of dispersed aggregated dot-like portions 11 each having an average diameter of 2 mm formed by impregnated and adhered resin.

### COMPARATIVE EXAMPLE 1

A mat for use in an automobile was obtained in the same manner as in Example 1 except that no water repellent agent was contained in the first water type resin emulsion 31.

Each mat for use in an automobile obtained as explained above was evaluated

<Slip Resistance Evaluation Method>

Each mat 1 was cut into a test piece 1A having a size of 210 mm by 290 mm. Then, as shown in FIG. 8, the test piece 1A was disposed on a carpet (needle-punched nonwoven fabric of 400 g/M²) with the nonwoven fabric layer of the test piece 1A facing downward, and further a weight 51 of 8 kg (200 mm×200 mm) was disposed on the test piece 1A to apply a load. With this state, the maximum tensile load N was measured by pulling the one end of the test piece 1A to cause a slip of the test piece 1A on the carpet 50. The test across the nap and the test against the nap were repeated 5 times, respectively, and each average value was obtained as a maximum tensile strength.

<Permeability Measuring Method>

In accordance with JIS L1096 8.27.1 A method, the permeability (cm³/cm²/sec) was measured.

<Water Repellent Evaluation Method>

Normal temperature water of 100 mL was calmly placed on the upper surface (pile surface) of the mat for use in an automobile, and left as it is for 10 minutes. 10 minutes later, the water penetration to the mat rear surface was investigated.

TABLE 1

| | Slip prevention performance | | | |
|---|---|---|---|---|
| | evaluation | | Perme- | |
| | Maximum tensile load (N) | | ability | Water |
| | Across | Against | (cm³/ | repellent |
| | the nap | the nap | cm²/sec) | evaluation |
| Example 1 | 162 | 170 | 38 | ⊚ |
| Example 2 | 137 | 139 | 37 | ⊚ |
| Example 3 | 100 | 112 | 40 | ◯ |
| Com. Ex. 1 | 87 | 92 | 45 | Δ |

(Evaluation standard)
“⊚” . . . No water penetration to the mat rear surface occurred, and the rear surface was in a dried state
“◯” . . . No water penetration to the mat rear surface occurred, but the rear surface was humid like a half-dried state
“Δ” . . . Almost no water penetration to the mat rear surface occurred, but the rear surface was wet by water
“X” . . . Water penetration to the mat rear surface occurred

As will be apparent from the above Table, each mat for use in an automobile according to Examples 1 to 3 was excellent in permeability, sound absorbing performance and slip prevention performance, and had sufficient water repellent performance.

To the contrary, in the mat according to Comarative Example 1 which falls outside the scope of the present invention was insufficient in slip prevention performance.

It should be appreciated that the terms and descriptions herein are not used for limiting the scope of the invention, but used only for explaining embodiments of the present invention, and the invention is not limited to them. The invention permits any modifications and substitutions within the scope of the present invention defined by the appended claims.

What is claimed is:

1. A method of manufacturing a mat for use in an automobile, comprising:
a first application step for applying first water type resin emulsion containing water repellent agent onto one surface of a nonwoven fabric;
a second application step for applying second water type resin emulsion containing resin having a glass transition temperature of 55° C. or below on the first water type resin emulsion applied surface of the nonwoven fabric; and
a lamination step for integrally laminating a surface skin material on the other surface of the nonwoven fabric after the second application step.

2. A method of manufacturing a mat for use in an automobile, comprising:
a first application step for applying first water type resin emulsion containing water repellent agent onto one surface of a nonwoven fabric;
a second application step for applying second water type resin emulsion containing resin having a glass transition temperature of 55° C. or below on the other surface of the nonwoven fabric; and
a lamination step for integrally laminating a surface skin material on the one surface of the nonwoven fabric after the second application step.

3. A method of manufacturing a mat for use in an automobile, comprising:
a lamination step for laminating a nonwoven fabric and a surface skin material to obtain a laminated sheet;
a first application step of applying first water type resin emulsion containing water repellent agent onto a rear surface of the nonwoven fabric of the laminated sheet;
a second application step for applying second water type resin emulsion containing resin having a glass transition temperature of 55° C. or below on the rear surface of the nonwoven fabric of the laminated sheet after the first application step.

4. The method of manufacturing a mat for use in an automobile as recited in any one of claims 1 to 3, wherein as the first water type resin emulsion to be used at the first application step, water type resin emulsion having a solid content of 30 to 60 mass % containing water repellent agent of 0.5 to 60 mass parts with respect to resin 100 mass parts is used, and wherein as the second water type resin emulsion to be used at the second application step, water type resin emulsion having a solid content of 30 to 60 mass % is used.

5. The method of manufacturing a mat for use in an automobile as recited in any one of claims 1 to 3, wherein a number of aggregated dot-like portions made of resin are formed on the second water type resin emulsion applied surface of the nonwoven fabric by applying the second water type resin emulsion.

6. The method of manufacturing a mat for use in an automobile as recited in any one of claims 1 to 3, wherein fluorine series water repellent agent is used as the water repellent agent.

7. A mat for use in an automobile, wherein a nonwoven fabric layer is integrally laminated at a lower surface side of a surface skin material layer, wherein a water repellent resin impregnated layer impregnated with resin containing water repellent agent is formed within the nonwovern fabric at at least a part of the thickness direction of the nonwoven fabric layer, and wherein a slip preventing portion impregnated with resin having a glass transition temperature of 55° C. or below is formed on at least a rear surface of the nonwoven fabric layer.

8. The mat for use in an automobile as recited in claim 7, wherein the water repellent resin impregnated layer impregnated with resin containing water repellent agent is formed on the entirety of the nonwoven fabric layer.

9. The mat for use in an automobile as recited in claim 7, wherein the slip preventing portion is constituted by a number of dispersed aggregated dot-like portions each having a diameter of 0.5 to 5 mm formed by impregnated and adhered resin on the rear surface of the nonwoven fabric layer.

10. The mat for use in an automobile as recited in claim 7, wherein the slip preventing portion is constituted by a number of dispersed aggregated dot-like portions each having a diameter of 0.8 to 3 mm formed by impregnated and adhered resin on the rear surface of the nonwoven fabric layer.

11. The mat for use in an automobile as recited in claim 7, wherein the weight per unit area of the fibers constituting the nonwoven fabric layer is 100 to 750 g/m², wherein the adhered amount of the water repellent resin impregnated layer is 30 to 300 g/m², and wherein the adhered amount of the slip preventing portion is 50 to 300 g/m².

12. The mat for use in an automobile as recited in claim 7, wherein as the surface skin material layer, a carpet original fabric in which piles are embedded on an upper surface of a base fabric and a lower surface of the base fabric is precoat-processed is used, and wherein the surface skin material layer and the nonwoven fabric layer are integrally bonded via a permeable adhesive resin layer having weight per unit area of 30 to 500 g/m² formed by heating and fusing thermoplastic resin powder.

13. The mat for use in an automobile as recited in claim 7, wherein the water repellent agent is fluorine series water repellent agent.

14. A mat for use in an automobile, wherein a nonwoven fabric layer is integrally laminated at a lower surface side of a skin material layer, wherein a water repellent resin impregnated layer impregnated with resin containing water repellent agent is formed within the nonwovern fabric at at least a part of the thickness direction of the nonwoven fabric layer, and wherein a slip preventing portion impregnated with resin having a glass transition temperature of 55° C. or below is formed on at least a rear surface of the nonwoven fabric layer,
wherein the slip preventing portion is constituted by a number of dispersed aggregated dot-like portions each having a diameter of 0.5 to 5 mm formed by impregnated and adhered resin on the rear surface of the nonwoven fabric layer, and wherein the weight per unit area of the fibers constituting the nonwoven fabric layer is 100 to 750 g/m², wherein the adhered amount of the water repellent resin impregnated layer is 30 to 300 g/m², and wherein the slip preventing portion is 50 to 300 g/m².
